(19) United States
(12) Patent Application Publication
(10) Pub. No.: US 2024/0044049 A1
(43) Pub. Date: Feb. 8, 2024

(54) FIBER FOR ARTIFICIAL HAIR

(71) Applicant: Denka Company Limited, Tokyo (JP)

(72) Inventors: Takashi Muraoka, Tokyo (JP); Yuki Sagara, Tokyo (JP)

(73) Assignee: Denka Company Limited, Tokyo (JP)

(21) Appl. No.: 18/257,086

(22) PCT Filed: Oct. 21, 2021
(86) PCT No.: PCT/JP2021/038937

§ 371 Date: Jun. 12, 2023

(30) Foreign Application Priority Data
Dec. 24, 2020 (JP) 2020-214636

(51) Int. Cl. D01F 1/10; D01F 6/10; D01D 5/084; A41G 3/00; C08L 27/06

(52) U.S. Cl. CPC D01F 1/10; D01F 6/10; D01D 5/084; A41G 3/0083; C08L 27/06; D10B 2503/08; D10B 2321/041; D10B 2401/20

(57) ABSTRACT

A fiber for artificial hair, the fiber comprising a synthetic resin and a microparticle, wherein a content difference |C₁-C₂| between a content C₁ of a microparticle of smaller than 2 μm in particle size, and a content C₂ of a microparticle of 2 μm or larger and smaller than 5 μm in particle size is 70% by mass or less based on the total amount of the microparticle, and the content of a microparticle of 5 μm or larger in particle size, C₃, is less than 25% by mass based on the total amount of the microparticle.

### TECHNICAL FIELD

The present invention relates to a fiber to be used for artificial hair attachable to and detachable from the head (hereinafter, referred to as “fiber for artificial hair”, simply) such as whole wigs, hair wigs, and hair extensions.

### BACKGROUND ART

Polyvinyl chloride fibers have superior strength, elasticity, and so on, and widely used for fibers for artificial hair that constitute decorative products for hair. Various special ideas to make synthetic resin fibers alike human hair have been applied to such fibers for artificial hair for their appearance and the like.

For example, Patent Literature 1 discloses, for natural appearance without glistening or like appearance, imparting lower gloss by providing a fiber with a hexagonal cross-sectional shape and then forming a recess along each side of the cross-section.

### CITATION LIST

### Patent Literature

Patent Literature 1: Japanese Utility Model Publication No. 60-14729

### SUMMARY OF INVENTION

### Technical Problem

However, imparting lower gloss by such a method has not led to successful reproduction of the texture of human hair under light such as sunlight, leaving a disadvantage of being readily discernible as a synthetic resin fiber.

The present invention was made in view of such circumstances, and an object of the present invention is to provide a fiber for artificial hair, the fiber having even lower gloss imparted and being less discernible as a synthetic resin fiber than conventional ones.

### Solution to Problem

The present invention, which was made in view of the issue mentioned above, was completed through a finding that the problem can be solved by using a microparticle having a specific particle size distribution.

Specifically, the present invention is as follows.
[1] A fiber for artificial hair, the fiber comprising a synthetic resin and a microparticle, wherein
   a content difference |C₁-C₂| between a content C₁ of a microparticle of smaller than 2 μm in a particle size, and a content C₂ of a microparticle of 2 μm or larger and smaller than 5 μm in a particle size is 70% by mass or less, based on the total amount of the microparticle, and
   a content C₃ of a microparticle of 5 μm or larger in a particle size is less than 25% by mass based on the total amount of the microparticle.
[2] The fiber for the artificial hair according to [1], wherein
   the content C₁ of the microparticle of smaller than 2 μm in the particle size, is 10 to 80% by mass based on the total amount of the microparticle, and
   the content C₂ of the microparticle of 2 μm or larger and smaller than 5 μm in the particle size, is 20 to 90% by mass based on the total amount of the microparticle.
[3] The fiber for the artificial hair according to [1] or [2], wherein the microparticle is an organic microparticle.
[4] The fiber for the artificial hair according to any one of [1] to [3], wherein the content of the microparticle is 0.5 to 5.0 parts by mass based on 100 parts by mass of the synthetic resin.
[5] The fiber for the artificial hair according to any one of [1] to [4], wherein
   the synthetic resin comprises:
   to 99 parts by mass of a non-crosslinked vinyl chloride resin having a viscosity-average degree of polymerization of 450 to 1700; and
   10 to 1 parts by mass of a crosslinked vinyl chloride resin having a viscosity-average degree of polymerization of 700 to 2300.

### Advantageous Effects of Invention

The present invention can provide a fiber for artificial hair, the fiber having even lower gloss imparted and being less discernable as a synthetic resin fiber than conventional ones.

### BRIEF DESCRIPTION OF DRAWING

FIG. 1 shows a schematic diagram illustrating a mode of measurement of the glossiness properties of fibers for artificial hair by a goniophotometer.

### DESCRIPTION OF EMBODIMENTS

Hereinafter, embodiments of the present invention (hereinafter, referred to as “the present embodiment”) will be described in detail; however, the present invention is not limited thereto, and various modification can be made without departing from the gist.

[Fiber for Artificial Hair]

The fiber for artificial hair according to the present embodiment contains a synthetic resin and a microparticle, wherein a content difference |C₁-C₂| between a content C₁ of a microparticle of smaller than 2 μm in a particle size, and a content C₂ of a microparticle of 2 μm or larger and smaller than 5 μm in a particle size is 70% by mass or less, based on the total amount of the microparticle, and a content C₃ of a microparticle of 5 μm or larger in a particle size is less than 25% by mass, based on the total amount of the microparticle.

In the present embodiment, the use of a microparticle having such a particle size distribution can provide generally low glossiness to light applied from multiple directions, and widen the angular width that allows reflection with glossiness equal to or higher than a certain level when light is applied from multiple directions.

Here, the expression having generally low glossiness to light applied from multiple directions means that when light reflection is observed with the angles of incident light and reflected light varied by using a goniophotometer or the like, the maximum glossiness is low. Thereby, the fiber for artificial hair can exhibit a natural feeling of gloss, without exhibiting excessive gloss whatever angle the fiber for artificial hair is observed from. Hereinbelow, maximum glossiness when light reflection is observed with the angles of incident light and reflected light varied is also referred to as “peak top luminous intensity”.

The expression that the angular width that allows reflection with glossiness equal to or higher than a certain level when light is applied from multiple directions is wide means that when light reflection is observed with various angles of incident light and reflected light varied by a goniophotometer or the like, the angular range (width of light-receiving angle) that allows reflection with specific glossiness is wide. Thereby, the fiber for artificial hair exhibits gloss to some degree whatever angle the fiber for artificial hair is observed from. While fibers for artificial hair that reflect with specific glossiness only to defined angles are readily discernible as a synthetic resin fiber, in contrast to them, the fiber for artificial hair that can reflect with specific glossiness to a wide range of angles has glossiness properties closer to those of human hair, thus being capable of reproducing a texture closer to that of human hair. Hereinbelow, an angular range in which, when light reflection is observed with the angles of incident light and reflected light varied, reflection takes place with a glossiness equal to or higher than half of peak top luminous intensity is also referred to as “half width”.

The following describes in detail the configuration of the fiber for artificial hair according to the present embodiment.

[Synthetic Resin]

Examples of the synthetic resin include, but are not limited to, vinyl chloride resins, polyethylene resins, nylon resins, polyester resins, and ethylene-vinyl alcohol resins. Among them, the synthetic resin is preferably a vinyl chloride resin, a nylon resin, or a polyester resin, and more preferably a vinyl chloride resin. Use of such a fiber tends to highly improve qualities including processability and hand feel, and provide lower production cost. The fiber for artificial hair according to the present embodiment may consist of one synthetic resin, and a mixture of two or more synthetic resins made of different materials may be used therefor.

Examples of vinyl chloride resins include, but are not limited to, homopolymer resins, which are homopolymers of vinyl chloride, and various copolymer resins. One vinyl chloride resin may be used alone, or two or more vinyl chloride resins may be used in combination. Use of such a fiber tends to highly improve qualities including processability and hand feel. The fiber for artificial hair according to the present embodiment may consist of one fiber, or a mixture of two or more fibers made of different materials may be used therefor.

In the present embodiment, the vinyl chloride resin may be a non-crosslinked vinyl chloride resin or a crosslinked vinyl chloride resin, and inclusion of both a non-crosslinked vinyl chloride resin and a crosslinked vinyl chloride resin is preferred.

(Non-Crosslinked Vinyl Chloride Resin)

The non-crosslinked vinyl chloride resin may be a homopolymer resin or a copolymer resin. Examples of the copolymer resin as the non-crosslinked vinyl chloride resin include, but are not limited to, copolymer resins of vinyl chloride and vinyl ester such as vinyl chloride-vinyl acetate copolymer resins and vinyl chloride-vinyl propionate copolymer resins; copolymer resins of vinyl chloride and acrylate such as vinyl chloride-butyl acrylate copolymer resins and vinyl chloride-2-ethylhexyl acrylate copolymer resins; copolymer resins of vinyl chloride and olefin such as vinyl chloride-ethylene copolymer resins and vinyl chloride-propylene copolymer resins; and vinyl chloride-acrylonitrile copolymer resins.

Among them, mixtures of a vinyl chloride resin and a chlorinated vinyl chloride resin and vinyl chloride-acrylonitrile copolymers are preferred. Use of such resins tend to highly improve qualities including processability, smoothness, and hand feel.

The viscosity-average degree of polymerization of the non-crosslinked vinyl chloride resin, V₁, is preferably 450 to 1700, more preferably 550 to 1600, and even more preferably 650 to 1500. The configuration that the viscosity-average degree of polymerization, V₁, is 450 or higher tends to provide the fiber for artificial hair with highly improved strength. The configuration that the viscosity-average degree of polymerization, V₁, is 1700 or lower tends to make the fiber less likely to be broken, thus giving highly improved productivity.

200 mg of a resin is dissolved in 50 mL of nitrobenzene, and the specific viscosity of the resulting polymer solution is measured by using a Ubbelohde viscosimeter in a thermostatic chamber at 30° C. to calculate the viscosity-average degree of polymerization in accordance with JIS-K6721.

The content of the non-crosslinked vinyl chloride resin is preferably 90 to 99 parts by mass, and more preferably 95 to 97 parts by mass, based on 100 parts by mass of the vinyl chloride resin. The configuration that the content of the non-crosslinked vinyl chloride resin is 99 parts by mass or less tends to provide the fiber for artificial hair with highly improved glossiness properties. The configuration that the content of the non-crosslinked vinyl chloride resin is 90 parts by mass or more tends to provide the fiber for artificial hair with highly improved spinnability.

(Crosslinked Vinyl Chloride Resin)

“Crosslinked” for the crosslinked vinyl chloride resin means having branching points in the polymer chain, thus having nonlinear structure. On the other hand, “non-crosslinked” for the above non-crosslinked vinyl chloride resin means not having a branching point in the polymer chain, thus having linear structure.

Such a crosslinked vinyl chloride resin is obtained through polymerization with addition of a polyfunctional monomer. Examples of the polyfunctional monomer to be used in this situation include, but are not limited to, diacrylate compounds such as polyethylene glycol diacrylate and bisphenol A-modified diacrylate. The crosslinked vinyl chloride resin is a mixture of: a gel component having a crosslinked structure and containing, as a main component, vinyl chloride, which is insoluble in tetrahydrofuran; and a polyvinyl chloride component, which is soluble in tetrahydrofuran.

The viscosity-average degree of polymerization of the component soluble in tetrahydrofuran, V₂, in the crosslinked vinyl chloride resin is preferably 700 to 2300, more preferably 1000 to 2200, and even more preferably 1300 to 2100. The configuration that the viscosity-average degree of polymerization of the component soluble in tetrahydrofuran, V₂, is within the range tends to provide the fiber for artificial hair with highly improved braidability and spinnability.

The viscosity-average degree of polymerization of the component soluble in tetrahydrofuran in the crosslinked vinyl chloride resin is measured as follows. One gram of the crosslinked vinyl chloride resin is added to 60 mL of tetrahydrofuran, and left to stand for approximately 24 hours. Then, the resin is sufficiently dissolved by using an ultrasonic washer. Insoluble matters in the tetrahydrofuran solution are separated by using an ultracentrifuge (30000 rpm×1 hour), and the THF solvent as the supernatant is collected. Thereafter, the THF solvent is volatilized, and the viscosity-average degree of polymerization is measured in the same manner as for the non-crosslinked vinyl chloride resin.

The difference between the viscosity-average degree of polymerization of the non-crosslinked vinyl chloride resin, V₁, and the viscosity-average degree of polymerization of the component soluble in tetrahydrofuran in the crosslinked vinyl chloride resin, V₂, |V₁-V₂| is preferably 600 to 1850, and more preferably 800 to 1500. The configuration that the difference in viscosity-average degree of polymerization is 600 or larger tends to provide highly improved glossiness properties. The configuration that the difference in viscosity-average degree of polymerization is 1850 or smaller tends to provide highly improved spinnability.

The content of the crosslinked vinyl chloride resin is preferably 1 to 10 parts by mass, and more preferably 3 to 5 parts by mass based on 100 parts by mass of the vinyl chloride resin. The configuration that the content of the crosslinked vinyl chloride resin is 1 part by mass or more tends to provide the fiber for artificial hair with highly improved glossiness properties. The configuration that the content of the crosslinked vinyl chloride resin is 10 parts by mass or less tends to provide the fiber for artificial hair with highly improved spinnability.

Examples of nylon resins include, but are not limited to, nylon 6, nylon 66, nylon 11, nylon 12, nylon 6/10, nylon 6/12, and copolymers of any of them. One nylon resin may be used alone, or two or more nylon resins may be used in combination.

Among them, nylon 6, nylon 66, and copolymers of nylon 6 and nylon 66 are preferred. Use of such resins tend to highly improve qualities including processability, smoothness, and hand feel.

[Microparticles]

The fiber for artificial hair according to the present embodiment contains a microparticle having a specific particle size distribution.

Examples of the microparticle include, but are not limited to, an organic microparticle made of acrylic resin, polyester resin, polyamide, silicone resin, polystyrene resin, polyethylene resin, nylon resin, or copolymer resin of any monomers constituting these resins, or the like; and an inorganic microparticle made of silica, calcium carbonate, aluminum oxide, titanium oxide, zinc oxide, calcium phosphate, barium sulfate, kaolinite, talc, or mica, or the like. The organic microparticle may be made of crosslinked resin. The inorganic microparticle may be surface-treated. One of those types of a microparticle may be used alone, and two or more thereof may be used in combination.

Among them, the organic microparticle are preferred, and those made of acrylic resin, polystyrene resin, silicone resin, or nylon resin are more preferred. Use of such microparticle tends to lower the peak top luminous intensity and widen the half width to a higher degree, thus providing the fiber for artificial hair with glossiness properties that include lowered gloss and are closer to those of human hair.

The content of the microparticle is preferably 0.1 to 20 parts by mass, more preferably 0.3 to 10 parts by mass, and even more preferably 0.5 to 5.0 parts by mass based on 100 parts by mass of the synthetic resin. The configuration that the content of the microparticle is within the range tends to lower the peak top luminous intensity and widen the half width to a higher degree, thus providing the fiber for artificial hair with glossiness properties that include lowered gloss and are closer to those of human hair.

The content C₁ of the microparticle of smaller than 2 μm in particle size, is preferably 10 to 80% by mass, more preferably 20 to 70% by mass, and even more preferably 30 to 60% by mass based on the total amount of the microparticle. The configuration that the content C₁ is within the range tends to lower the peak top luminous intensity and widen the half width to a higher degree, thus providing the fiber for artificial hair with glossiness properties that include lowered gloss and are closer to those of human hair.

The content C₂ of a microparticle of 2 μm or larger and smaller than 5 μm in particle size, is preferably 20 to 90% by mass, more preferably 30 to 80% by mass, and even more preferably 40 to 70% by mass based on the total amount of the microparticle. The configuration that the content C₂ is within the range tends to lower the peak top luminous intensity and widen the half width to a higher degree, thus providing the fiber for artificial hair with glossiness properties that include lowered gloss and are closer to those of human hair.

The content C₃ of a microparticle of 5 μm or larger in particle size is less than 25% by mass, preferably 20% by mass or less, more preferably 15% by mass or less, even more preferably 10% by mass or less, and particularly preferably 5.0% by mass or less based on the total amount of the microparticle. The microparticle of 5 μm or larger in particle size may not be contained. The configuration that the content C₃ is within the range tends to lower the peak top luminous intensity and widen the half width to a higher degree, thus providing the fiber for artificial hair with glossiness properties that include lowered gloss and are closer to those of human hair. Moreover, the configuration that the content C₃ is within the range tends to prevent the fiber for artificial hair from becoming whitish, thus providing highly improved color tone.

The content difference |C₁-C₂| between the content C₁ and the content C₂ is 70% by mass or less, preferably 1 to 60% by mass, more preferably 1 to 50% by mass, even more preferably 1 to 40% by mass, further preferably 1 to 30% by mass, furthermore preferably 1 to 20% by mass, and particularly preferably 1 to 10% by mass. The configuration that the content difference |C₁-C₂| is within the range allows the microparticle to be constituted to have a broad particle size distribution in the particle size region of smaller than 5 μm. This result tends to lower the peak top luminous intensity and widen the half width to a higher degree, thus providing the fiber for artificial hair with glossiness properties that include lowered gloss and are closer to those of human hair.

The total of the content C₁ and the content C₂ is preferably 75% by mass or more, more preferably 80% by mass or more, even more preferably 85% by mass or more, further preferably 90% by mass or more, and furthermore preferably 95% by mass or more. The configuration that the total of the content C₁ and the content C₂ is within the range tends to lower the peak top luminous intensity of the microparticle and widen the half width thereof to a higher degree, thus providing the fiber for artificial hair with glossiness properties that include lowered gloss and are closer to those of human hair.

Adjustment to the thus-described particle size distribution can be achieved by classifying the microparticles by particle size, and removing some microparticles having a specific particle size or mixing microparticles having a specific particle size therein.

[Additional Additives]

An additional additive may be used for the fiber for artificial hair according to the present embodiment, as necessary. The additional additive may be attached to the surface of the fiber for artificial hair, or mixed in the resin composition constituting the fiber.

Examples of the additional additive include, but are not limited to, flame retardants, thermal stabilizers, and lubricants. If a compound corresponding to any of the above specific compounds attaches, as a thermal stabilizer or a lubricant, to the surface of the fiber for artificial hair, the amount is to be limited to the total content of the specific compounds.

(Flame Retardant)

Any conventionally known flame retardant is applicable, without limitation, and examples thereof include bromine compounds, halogen compounds, phosphorus-containing compounds, phosphorus-halogen compounds, nitrogen compounds, and metal hydroxide-phosphorus-nitrogen compounds. Among them, bromine compounds as bromine-containing flame retardants, phosphorus-containing compounds as phosphorus-containing flame retardants, and nitrogen compounds as nitrogen-containing flame retardants are preferred.

The content of the flame retardant is preferably 3 to 30 parts by mass, and more preferably 10 to 20 parts by mass based on 100 parts by mass of the synthetic resin.

(Thermal Stabilizer)

Any conventionally known thermal stabilizer is applicable, without limitation, and examples thereof include tin thermal stabilizers, Ca—Zn thermal stabilizers, hydrotalcite thermal stabilizers, epoxy thermal stabilizers, and β-diketone thermal stabilizers. Among them, Ca—Zn thermal stabilizers and hydrotalcite thermal stabilizers are preferred. Use of such thermal stabilizers advantageously provide artificial hair products with prolonged product lifetime, prevents the fiber from discoloring, and prevents the pyrolysis of the composition in forming the fiber. One thermal stabilizer may be used alone, or two or more thermal stabilizers may be used in combination.

Examples of tin thermal stabilizers include, but are not limited to, mercaptotin thermal stabilizers such as dimethyltin mercapto, dimethyltin mercaptide, dibutyltin mercapto, dioctyltin mercapto, dioctyltin mercapto polymer, and dioctyltin mercapto acetate; maleate tin thermal stabilizers such as dimethyltin maleate, dibutyltin maleate, dioctyltin maleate, and dioctyltin maleate polymer; and laurate tin thermal stabilizers such as dimethyltin laurate, dibutyltin laurate, and dioctyltin laurate.

Examples of Ca—Zn thermal stabilizers include, but are not limited to, zinc stearate, calcium stearate, zinc 12-hydroxystearate, and calcium 12-hydroxystearate.

Examples of hydrotalcite thermal stabilizers include, but are not limited to, composite salt compounds consisting of magnesium and/or alkali metal and aluminum or zinc, composite salt compounds consisting of magnesium and aluminum, and compounds formed by removing crystal water from any of the composite salt compounds through dehydration.

Examples of epoxy thermal stabilizers include, but are not limited to, epoxidized soybean oil and epoxidized linseed oil.

Examples of β diketone thermal stabilizers include, but are not limited to, stearoyl benzoyl methane and dibenzoyl methane.

The content of the thermal stabilizer is preferably 0.1 to 5.0 parts by mass, and more preferably 1.0 to 3.0 parts by mass based on 100 parts by mass of the synthetic resin. The configuration that the content of the thermal stabilizer is within the range tends to provide artificial hair products with prolonged product lifetime, prevent the fiber from discoloring, and prevent the pyrolysis of the composition in forming the fiber.

(Lubricant)

Any conventionally known lubricant is applicable, without limitation, and examples thereof include metal soap lubricants, higher fatty acid lubricants, ester lubricants, and higher alcohol lubricants. Use of such lubricants is effective, not only for touch feeling, but also for controlling the melt state of the composition and the adhesion state of the composition to metal surfaces of screws, cylinders, dies, etc., in an extruder. One lubricant may be used alone, or two or more lubricants may be used in combination.

Examples of metal soap lubricants include, but are not limited to, metal soaps of stearate, laurate, palmitate, or oleate of Na, Mg, Al, Ca, or Ba.

Examples of higher fatty acid lubricants include unsaturated fatty acids such as stearic acid, palmitic acid, myristic acid, lauric acid, and capric acid, and mixtures of any of them.

Examples of higher alcohol lubricants include stearyl alcohol, palmityl alcohol, myristyl alcohol, lauryl alcohol, and oleyl alcohol.

Examples of ester lubricants include ester lubricants formed of alcohol and fatty acid; pentaerythritol lubricants such as monoester, diester, triester, or tetraester of pentaerythritol or dipentaerythritol and higher fatty acid, or a mixture of any of them; and montanic acid wax lubricants such as esters of montanic acid and higher alcohol such as stearyl alcohol, palmityl alcohol, myristyl alcohol, lauryl alcohol, and oleyl alcohol.

The content of the lubricant is preferably 0.2 to 5.0 parts by mass, and more preferably 1.0 to 4.0 parts by mass based on 100 parts by mass of the synthetic resin. The configuration that the content of the lubricant is within the range tends to prevent increased die pressure in spinning, thread breakage, and increased nozzle pressure, and so on, thus providing highly improved production efficiency.

Applicable in addition to the above additives are processing aids, matting agents, plasticizers, strengtheners, ultraviolet absorbers, antioxidants, antistatic agents, fillers, flame retardants, pigments, coloring improvers, conductivity-imparting agents, perfumes, and so on.

(Peak Top Luminous Intensity)

The peak top luminous intensity of the fiber for artificial hair according to the present embodiment is preferably 60 or lower, more preferably 40 to 58, and even more preferably 45 to 56. The configuration that the peak top luminous intensity, which is maximum glossiness when light reflection is observed with the angles of incident light and reflected light varied, is 60 or lower tends to provide generally low glossiness to light applied from multiple directions. The peak top luminous intensity can be measured with a method described in Examples.

(Half Width)

The half width of the fiber for artificial hair according to the present embodiment is preferably 6° or larger, more preferably 7 to 20°, and even more preferably 8 to 15°. The configuration that the half width, which is an angular width that allows reflection with glossiness equal to or higher than a certain level when light is applied from multiple directions, is 6° or larger tends to provide the fiber for artificial hair with glossiness properties close to those of human hair. The half width can be measured with a method described in Examples.

[Production Method for Fiber for Artificial Hair]

Any production method may be used for the fiber for artificial hair according to the present embodiment, without limitation, and examples thereof include a method including a step of spinning a composition containing the above synthetic resin and the microparticle, and, as necessary, additives, to give a synthetic resin fiber.

(Preparation of Composition)

The composition to be spun may be a pellet compound obtained in such a manner that the synthetic resin, the microparticle, and additives for use as necessary are mixed together by using a Henschel mixer, a Super mixer, a ribbon blender, or the like, and the resulting powder compound is melt-mixed.

Either hot blending or cold blending may be used as a production method for the powder compound, and normal production conditions can be used. From the viewpoint of reducing volatile components in the composition, it is preferable to use hot blending with the cut temperature in blending increased to 105° C. to 155° C.

Applicable for production of the pellet compound are, for example, single-screw extruders, counter-rotating twin-screw extruders, conical twin-screw extruders, co-rotating twin-screw extruders, co-kneaders, planetary-gear extruders, and kneaders such as roll kneaders.

Any conditions may be used in production of the pellet compound, without limitation, but it is preferable to set the resin temperature to 185° C. or lower in order to prevent the thermal degradation of the composition. Metal pieces of a screw and fibers attaching to protective gloves can be slightly mixed in the pellet compound, and to remove them a mesh may be provided near the tip of each screw.

A cold cutting method may be employed for production of the pellet compound. A means to remove shavings that can be mixed in during cold cutting (fine powder generated in pellet production) may be employed. Since cutters are likely to be chipped to generate shavings through long-time use, it is preferable to appropriately exchange the cutters.

(Spinning Step)

In the spinning step, the composition obtained as described, for example, the pellet compound can be subjected to extrusion and melt spinning at a cylinder temperature ranging from 150° C. to 190° C. and a nozzle temperature of 180±15° C. The cross-sectional shape of the nozzle to be used in this situation can be appropriately set according to the cross-sectional shape of the fiber for artificial hair to be formed.

The melt-spun, unstretched synthetic resin fiber from the nozzle is introduced into a heating cylinder (heating cylinder temperature: 250° C.) and instantaneously heat-treated, and can be wound by a take-up machine placed at a position approximately 4.5 m immediately below the nozzle. During this winding, the take-up speed can be controlled so that the fineness of the unstretched thread can correspond to a desired thickness.

A conventionally known extruder may be used for converting the synthetic resin composition into an unstretched thread. For example, a single-screw extruder, a counter-rotating twin-screw extruder, a conical twin-screw extruder, or the like may be used.

(Stretching and Heat Treatment)

The unstretched synthetic resin fiber obtained as described can be subjected to stretching treatment and heat treatment. In an example, the fiber for artificial hair can be formed in such a manner that the unstretched synthetic resin fiber is stretched at a rate of 3 fold through a stretching machine (under air atmosphere, 105° C.), and then subjected to heat treatment (under air atmosphere, 110° C.) at a rate of 0.75 fold through a heat treatment machine (by causing thermal contraction until the whole fiber length reaches 75% of the length before the treatment through contraction) to adjust the fineness to 58 to 62 denier.

(Gear Processing)

In addition, the fiber for artificial hair obtained as described may be subjected to gear processing, as necessary. Gear processing is a method of crimping by passing a fiber bundle between two engaging gears at high temperature, and the material of the gears to be used, the shape of the teeth of each gear, and the number of the teeth of each gear are not limited. Depending on fiber material, fineness, gear-to-gear pressure conditions, etc., the wavy shape of crimps may vary, whereas the wavy shape of crimps can be controlled via the depth of each groove of the gear teeth shape, the surface temperature of the gears, and the processing speed.

The conditions for gear processing are not limited; however, preferably, the depth of each groove of the gear teeth shape is 0.2 mm to 6 mm, and more preferably 0.5 ram to 5 mm, the surface temperature of the gears is 30 to 100° C., and more preferably 40 to 80° C., and the processing speed is 0.5 to 10 m/min, and more preferably 1.0 to 8.0 m/min.

[Products Using Fibers for Artificial Hair]

The fiber for artificial hair according to the present embodiment can be preferably used for decorative products for the head such as hair wigs, hair pieces, braids, and extension hair.

### Examples

Hereinafter, the present invention will be described in more detail with reference to Examples and Comparative Examples. The present invention is by no means limited to Examples shown in the following.

1. Preparation of Synthetic Resin Fibers

Vinyl chloride resin compositions obtained by formulating a non-crosslinked vinyl chloride resin, a crosslinked vinyl chloride resin, and a microparticle at ratios shown in Table 1 below were each mixed in a blender, and compounding was performed by using an extruder having a diameter of 40 mm at a cylinder temperature ranging from 130 to 170° C. to form pellets. The resulting pellets were then melt-spun through an extruder.

Thereafter, the resultants were each subjected to heat treatment in a heating cylinder placed immediately below the nozzle for approximately 0.5 to 1.5 seconds, giving 150-dtex fibers. Subsequently, the fibers resulting from melt spinning were sequentially subjected to a step of stretching under an air atmosphere at 100° C. at a rate of 300% and a step of causing thermal contraction under an air atmosphere at 120° C. until the whole fiber length reached 75% of the length before the treatment through contraction, giving 67-dtex fibers for artificial hair. Results of various evaluations for the resulting fibers for artificial hair are shown in Table 1.

TABLE 1

| | | Example | | | | | | | | | Comparative Example | | | | |
|---|---|---|---|---|---|---|---|---|---|---|---|---|---|---|---|
| | | 1 | 2 | 3 | 4 | 5 | 6 | 7 | 8 | 9 | 1 | 2 | 3 | 4 | 5 |
| Microparticle | GM-0105 [part by mass] | 1.40 | 1.60 | 1.00 | | 1.30 | 0.32 | 4.80 | 1.60 | 1.60 | | 0.26 | | 1.30 | 0.40 |
| | GM-0205S [part by mass] | 0.40 | | | 2.00 | | | | | | | | | | |
| | GM-0449S-2 [part by mass] | | | | | 0.30 | | | | | | | 1.60 | | |
| | GM-0801S [part by mass] | | | | | 0.40 | | | | | | | 0.40 | 0.70 | |
| | MX-80H3wT [part by mass] | 0.20 | 0.40 | 1.00 | | | 0.08 | 1.20 | 0.40 | 0.40 | | 1.74 | | | 1.60 |
| | Total [part by mass] | 2.00 | 2.00 | 2.00 | 2.00 | 2.00 | 0.40 | 6.00 | 2.00 | 2.00 | 0.00 | 2.00 | 2.00 | 2.00 | 2.00 |
| | C₁(wt %) | 37 | 48 | 68 | 13 | 24 | 48 | 48 | 48 | 48 | 0 | 92 | 6 | 23 | 87 |
| | C₂(wt %) | 61 | 52 | 32 | 79 | 57 | 52 | 52 | 52 | 52 | 0 | 8 | 64 | 49 | 13 |
| | C₃(wt %) | 2 | 0 | 0 | 8 | 19 | 0 | 0 | 0 | 0 | 0 | | 30 | 28 | |
| | \|C₁ − C₂\| (wt %) | 24 | 4 | 36 | 66 | 33 | 4 | 4 | 4 | 4 | 0 | 84 | 58 | 26 | 74 |
| Synthetic | Non-crosslinked vinyl | 97 | 97 | 97 | 97 | 97 | 97 | 97 | 100 | 89 | 97 | 97 | 97 | 97 | 97 |
| resin | chloride resin [part by mass] | | | | | | | | | | | | | | |
| | Crosslinked vinyl chloride | 3 | 3 | 3 | 3 | 3 | 3 | 3 | 0 | 11 | 3 | 3 | 3 | 3 | 3 |
| | resin [part by mass] | | | | | | | | | | | | | | |
| Glossiness | Peak top luminous intensity | 52 | 52 | 51 | 53 | 54 | 58 | 35 | 59 | 30 | 64 | 52 | 54 | 54 | 49 |
| | Rating | ⊚ | ⊚ | ⊚ | ⊚ | ⊚ | Δ | ⊚ | Δ | ⊚ | X | ⊚ | ⊚ | ⊚ | ⊚ |
| | Half width | 8 | 9 | 8 | 7 | 7 | 7 | 11 | 9 | 9 | 4 | 4 | 6 | 8 | 5 |
| | Rating | ◯ | ⊚ | ◯ | ◯ | ◯ | ◯ | ⊚ | ⊚ | ⊚ | X | X | Δ | ◯ | X |
| Color tone | L value | 19 | 18 | 18 | 20 | 23 | 17 | 22 | 18 | 18 | 17 | 18 | 28 | 25 | 18 |
| | Rating | ⊚ | ⊚ | ⊚ | ◯ | Δ | ⊚ | Δ | ⊚ | ⊚ | ⊚ | ⊚ | X | X | ⊚ |

| | | | | | | | | | | | | | | |
|---|---|---|---|---|---|---|---|---|---|---|---|---|---|---|
| Hand feel | ◯ | ◯ | ◯ | ◯ | ◯ | ◯ | ◯ | ◯ | ◯ | ◯ | ◯ | ◯ | ◯ | ◯ |
| Spinnability | ◯ | ◯ | ◯ | ◯ | ◯ | ◯ | ◯ | ◯ | ◯ | ◯ | ◯ | ◯ | ◯ | ◯ |

### (Microparticles)

GANZPEARL GM-0105 (Aica Kogyo Company, Limited)
GANZPEARL GM-0205S (Aica Kogyo Company, Limited)
GANZPEARL GM-04495-2 (Aica Kogyo Company, Limited)
GANZPEARL GM-08015 (Aica Kogyo Company, Limited)
MX-80H3wT (Soken Chemical & Engineering Co., Ltd., average particle size: 0.8 μm)

### (Synthetic Resin)

Non-crosslinked vinyl chloride resin (manufactured by TAIYO VINYL CORPORATION, product name: TH1000)
Crosslinked vinyl chloride resin (manufactured by Shin-Etsu Chemical Co., Ltd., product name: GR800T)

2. Evaluation Methods

2.1. Glossiness Properties

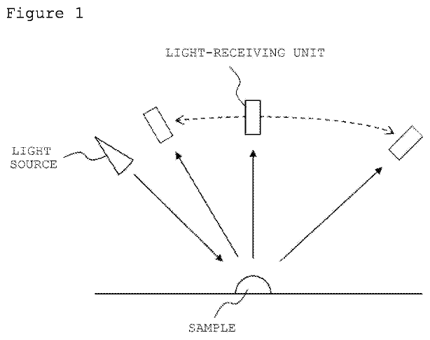

The glossiness of each fiber for artificial hair obtained as described was measured by using the goniophotometer GP-700 manufactured by MURAKAMI COLOR RESEARCH LABORATORY CO., LTD. FIG. 1 shows a schematic diagram of the goniophotometer. First, a reference fiber (manufactured by Denka Company Limited, the polyamide fiber for artificial hair Luxeena, hue #613T) was set on a sample stage, the sensitivity adjustment dial value (COARSE) was set to 718, the sensitivity adjustment dial value (FINE) was set to 737, the angle of incidence was set to 45°, and the intensity of incident light, the gain of the detector, and so on were adjusted to set the intensity of reflected light at a light-receiving angle of 45° to 80% of the detection limit of the apparatus.

Thereafter, a fiber for artificial hair obtained as described (fiber for evaluation) was set on the sample stage, and the intensity of reflected light was measured with the light-receiving angle varied from 10° to 80°. Then, the maximum value of the intensity of reflected light relative to the detection limit of the apparatus was acquired as the peak top luminous intensity [unit: %].

(Evaluation Criteria)
⊚: the peak top luminous intensity was 55 or lower
◯: the peak top luminous intensity was higher than 55 and 60 or lower
X : the peak top luminous intensity was higher than 60

A width of the light-receiving angle in which an intensity of reflected light equal to or higher than 50% of the peak top luminous intensity was given was acquired as the half width [unit: °].

(Evaluation Criteria)
⊚: the half width was 9° or larger
◯: the half width was 7° or larger and smaller than 9°
Δ: the half width was 6° or larger and smaller than
X : the half width was smaller than 5°

2.2. Color Tone

The color tone of a thread bundle of each fiber for artificial hair obtained as described was evaluated from an L value acquired through measurement with a spectrocolorimeter (COLOR-7X/Kurabo Industries Ltd., D-65 light source, measurement area: 5 mm×12 mm rectangle).

### (Evaluation Criteria)

⊚: the L value was lower than 20
◯: the L value was 20 or higher and lower than 22
Δ: the L value was 22 or higher and lower than 25
X : the L value was 25 or higher

2.3. Hand Feel

Hair bundles of the fibers after melt spinning were checked by touch, and rated by three-grade criteria as follows. Specifically, in rating of hand feel, evaluation was performed on the basis of the following criteria with use of the vinyl chloride fiber F-GM manufactured by Denka Company Limited as a reference sample.

### (Evaluation Criteria)

⊚: softer than the reference sample
◯: comparable to the reference sample
Δ: harder than the reference sample

2.4. Spinnability

During forming an unstretched thread by melt spinning, the occurrence of thread breakage was visually observed, and the spinnability was evaluated on the basis of the following evaluation criteria.

### (Evaluation Criteria)

◯: thread breakage occurred once or less/1 hour
Δ: thread breakage occurred two to three times/1 hour
X : thread breakage occurred four times or more/1 hour

### INDUSTRIAL APPLICABILITY

The present invention has industrial applicability as a fiber for artificial hair that is used for artificial hair attachable to and detachable from the head such as whole wigs, hair wigs, and hair extensions.

1. A fiber for artificial hair, the fiber comprising a synthetic resin and a microparticle, wherein
a content difference |C₁-C₂| between a content C₁ of the microparticle of smaller than 2 μm in a particle size, and a content C₂ of a microparticle of 2 μm or larger and smaller than lam in a particle size is 70% by mass or less, based on the total amount of the microparticle, and
a content C₃ of a microparticle of 5 μm or larger in a particle size is less than 25% by mass based on the total amount of the microparticle.

2. The fiber for the artificial hair according to claim 1, wherein
the content C₁ of the microparticle of smaller than 2 μm in the particle size, is 10 to 80% by mass based on the total amount of the microparticle, and
the content C₂ of the microparticle of 2 μm or larger and smaller than 5 μm in the particle size is 20 to 90% by mass based on the total amount of the microparticle.

3. The fiber for the artificial hair according to claim 1, wherein the microparticle is an organic microparticle.

4. The fiber for the artificial hair according to claim 1, wherein the content of the microparticle is 0.5 to 5.0 parts by mass based on 100 parts by mass of the synthetic resin.

5. The fiber for the artificial hair according to claim 1, wherein
the synthetic resin comprises:
90 to 99 parts by mass of a non-crosslinked vinyl chloride resin having a viscosity-average degree of polymerization of 450 to 1700; and
10 to 1 parts by mass of a crosslinked vinyl chloride resin having a viscosity-average degree of polymerization of 700 to 2300.
